(19) United States
(12) Patent Application Publication
(10) Pub. No.: US 2003/0115781 A1
(43) Pub. Date: Jun. 26, 2003

(54) Bottle with label

(76) Inventor: Robert Boutilier, Acton (CA)

Correspondence Address: Orange & Chari, 66 Wellington St. W., Suite 4900, P.O. Box 190, Toronto, ON, M5K 1H6, CA

(21) Appl. No.: 10/023,935

(22) Filed: Dec. 21, 2001

(51) Int. Cl. G09F 3/00

(52) U.S. Cl. 40/310

(57) ABSTRACT

A transparent liquid container bottle featuring a label with a uniformly solid color which contrasts with the color of the liquid contents of the bottle. The label extends from close to the base of the bottle to the base of the shoulder of the bottle. The width of the label is no greater than half the circumference of the bottle. This arrangement of the bottle imparts the color of the label to the liquid contents of the bottle,.

### FIELD OF THE INVENTION

The present invention relates generally to a liquid container bottle.

### BACKGROUND

Label or ornamental arrangements on bottles containing liquid beverages are known in which a label or ornament is disposed on one or both sides of a bottle in order to enhance the appearance of the liquid. The label or ornamental design also provides a novel and attractive background effect when the bottle is viewed in its normal display position, thereby enhancing the appearance of the bottle for merchandising purposes.

An example of such a label arrangement is seen on a bottle of “BanfICE Vodka”, which is available in liquor stores. This transparent bottle has on one side a label, whose inner face has the picture of a mountain range which can be seen through the opposite side of the bottle and its contents, which is also transparent, to give the appearance of a magnified mountain range coating the back of the bottle. The label, however, does not cover the entire surface of the bottle on which the label is attached.

An example of an ornamental design is seen on a bottle of “Chopin” Vodka, which is available in liquor stores. This bottle is substantially frosted on its outer surface with the exception of a substantially clear and transparent circular window on one side of the bottle. The bottle has the profile of the composer Chopin etched onto the bottle on the side directly opposite the clear and transparent circular window. When viewed through the window of a bottle filled with a transparent liquid such as vodka, the image of the etched profile of Chopin is magnified and gives the viewer the appearance of Chopin coating the back of the bottle.

Another example of a label arrangement is seen in U.S. Pat. No. 4,658,974 which issued to Fujita et al. on Apr. 21, 1987. In the label arrangement disclosed in this patent, a transparent liquid container bottle, has a label adhered to its outer periphery. The backside of the label is tinted with a color corresponding to the color of liquid in the bottle. The label is applied in such a manner that the color in the backside of the label can be seen through the liquid and the bottle due to the reflection and refraction of light. In order to make the liquid in the bottle appear to customers to be tinted, the upper portion of the bottle is not labeled. The height of this unlabeled section may be 0.1 to 2.0 times the diameter of the bottle and the width of the label is greater than half the circumference of the bottle.

The appearance of a bottle is of major concern in marketing a particular product. The image created by the bottle is used as part of a coherent marketing campaign. At the same time, for certain liquors, the containers must support the impression of the purity and therefore quality of the product so that obscuring the contents with a label is not acceptable. One image that is cultivated in the current market place is a monolithic uniform colour for the packaging. This would normally be provided by a label wrapped around the bottle but as noted above, such packaging is typically not acceptable.

It is a principle object of the present invention to provide a colored appearance for uncolored liquids contained in a transparent bottle.

### SUMMARY OF THE INVENTION

One aspect of the invention provides for a liquid container, preferably a bottle, having transparent walls with a first label extending over a substantial extent of one surface of the bottle. The label has on both its surfaces a uniform solid color which contrasts with the color of the contents of the bottle. The opposing surface of the label i.e., the surface not in contact with the bottle, can have indicia relating to information on the composition of the liquid, barcode, trademark, and manufacturer's or distributor's name and address. In the preferred embodiment, a second label, having the same color as the first label encircles the neck portion of the bottle. The height of the first label extends from close to the base of the bottle to the base of the shoulder of the bottle and the width of the label should not exceed half the circumference of the bottle.

As a further preference, the color of the label is black and the liquid contained within the bottle is clear.

### BRIEF DESCRIPTION OF THE DRAWINGS

The present invention will be understood more fully from the detailed description given below and from the accompanying drawings of the preferred embodiment of the invention, which, however, should not be taken to limit the invention to the specific embodiment but are for explanation and understanding only.

In the drawings:

FIG. 1 is a front view of a bottle;

FIG. 2 is a rear view of the bottle of FIG. 1;

FIG. 3 is an oblique view from above of the bottle of FIG. 1, in which the label is partially peeled away.

FIG. 4 is a longitudinal cross-sectional view of the bottle of FIG. 1,

FIG. 5 is a top view of the bottle of FIG. 1.

### DETAILED DESCRIPTION OF THE PREFERRED EMBODIMENT

It will be apparent from the following description that the invention is suitable for use in connection with many different types of containers and liquids. However, it finds its principle application in connection with the display and/or merchandising of liquids, such as, for example, alcoholic beverages which are customarily contained in attractive bottles to enhance the attractiveness and salability of the product.

The invention is most effective where both the container and the liquid are transparent. However, the invention may also be employed where either the liquid or the container or both are not clear and fully transparent but are sufficiently translucent to permit light to pass through the container with sufficient intensity to produce the desired effect described herein.

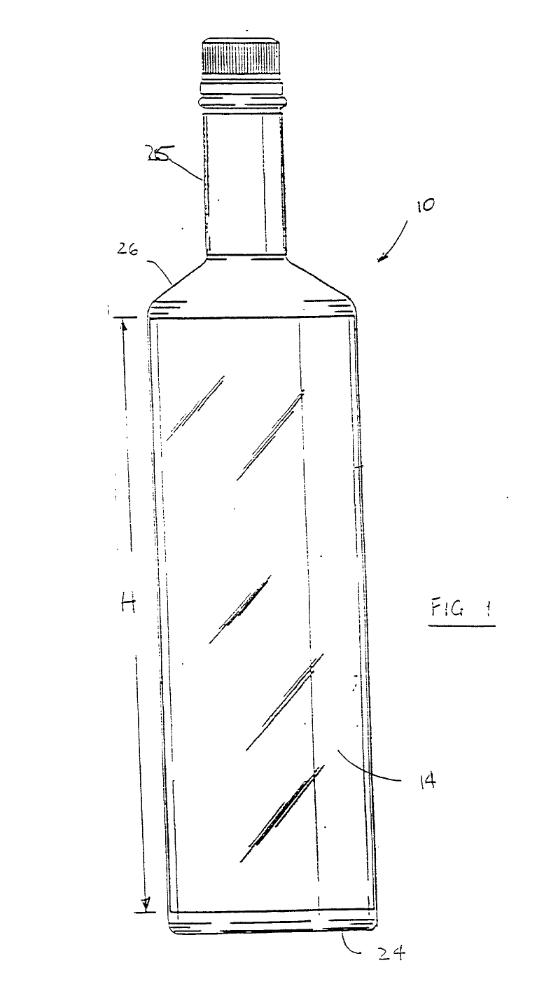

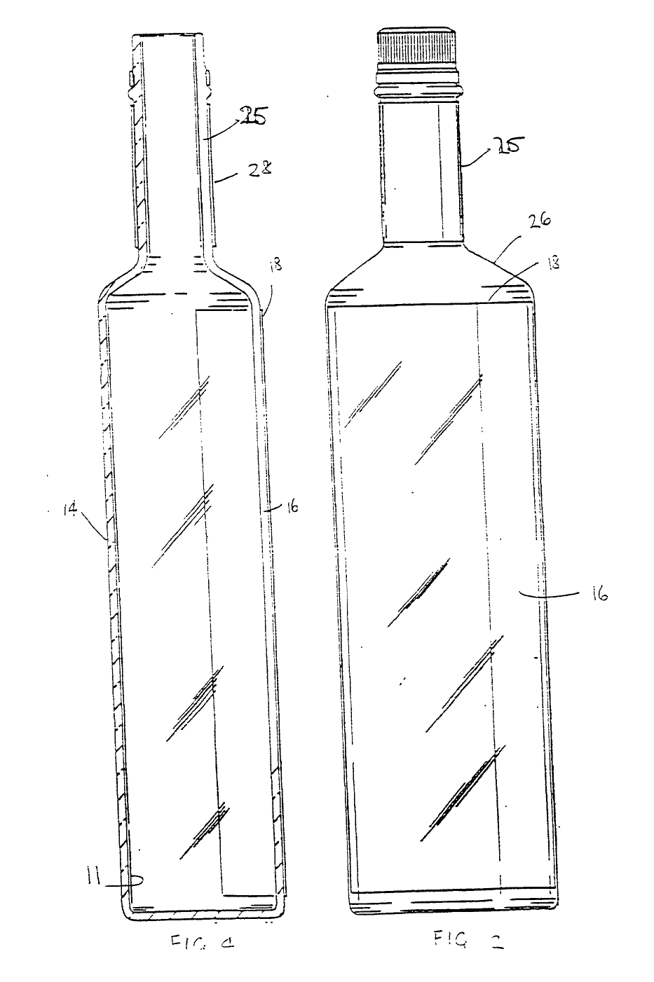

FIGS. 1 and 2 illustrate a bottle 10, which is in its main body portion 13 generally and preferably ellipsoidal, although the teachings of the invention are applicable as well to bottles of other forms including cylindrical, ovate and other various complicated forms. The bottle 10 is fabricated preferably from transparent glass or plastic. However, the bottle 10 may also be fabricated from other such materials which are not clear and fully transparent, but are sufficiently translucent to permit light to pass through the container with sufficient intensity to produce the desired effect described herein. The liquid contained within bottle 10 is a transparent, colorless alcoholic beverage, such as vodka, but may be a beverage which is not fully transparent, but is sufficiently translucent to permit light to pass through the liquid with sufficient intensity to produce the desired effect described herein.

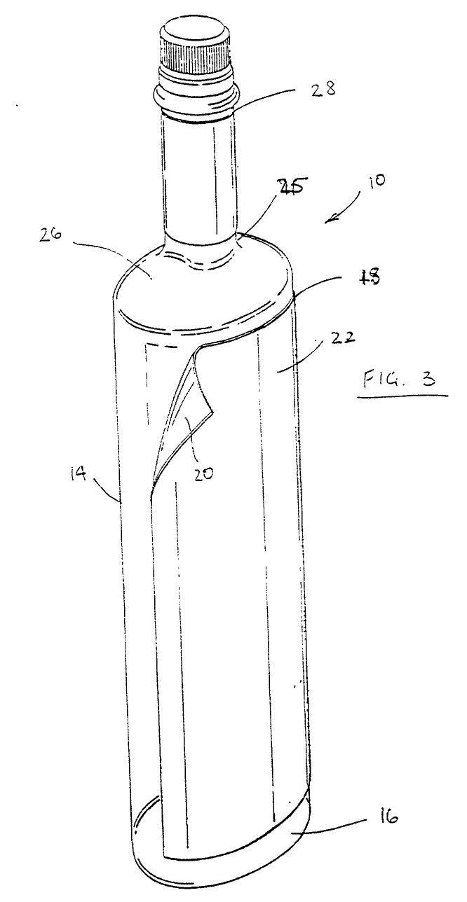

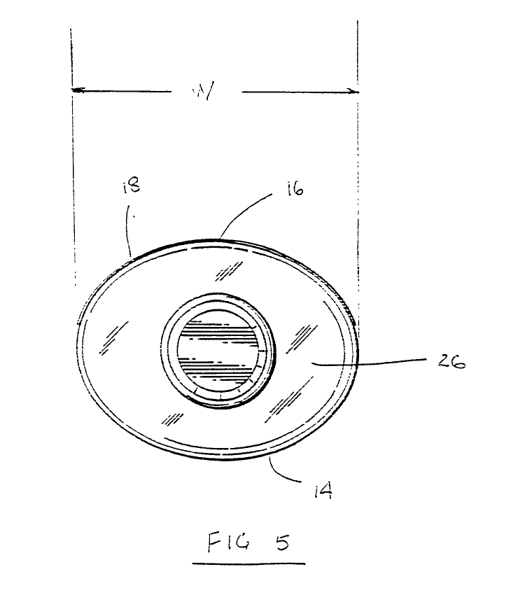

The bottle 10 is formed from a continuous wall, 11 having a “front” portion 14, which is directly in front of the viewer when the bottle is in its usual display position and a. “rear” portion 16 which is defined as the portion of the bottle directly opposite front portion 14. A label 18 is secured to the wall, 11. As seen in FIG. 3, the label 18, has two oppositely directed surfaces, 20, 22, The “inwardly” directed surface 20 of the label 18 is the surface, which will be in contact with the outwardly directed surface of the rear portion 16 of the bottle 10. The “outwardly” directed surface 22 of the label 18 is the surface which will be exposed to the outside and, on which the trademark, symbol, the name and type of the liquid, as well as information on the composition of the liquid, barcode, manufacturer's or distributor's name and address and so forth are printed. This arrangement of the label 18 relative to the rear portion 16 of the bottle 10 can be better seen in the close-up view in FIG. 4.

In the preferred embodiment, the entire inwardly directed surface 20 of the label 18 is of a uniformly solid color. The color to be used on the inwardly directed surface 20 of the label 18 should be selected to contrast the color of the liquid contained within the bottle. In the preferred embodiment, the color to be used on the inwardly directed surface 20 of the label 18 is black, which contrasts with the color of the transparent, uncolored and non-tinted liquid, which in the preferred embodiment is the alcoholic beverage vodka. In the preferred embodiment, the color on the outwardly directed surface 22 of the label will be identical to the color of the inwardly directed surface 20 of the label.

It will be appreciated however, that the outwardly directed surface 22 of the label 18 and the inwardly directed surface 20 may be colored with a first and second color respectively. Where the first and second colors are different or are of two different shades of the same color. Alternatively, the first and second color, in combination, may thus produce a third color. This of course means that the substrate of label 18 on which the colors are applied must be transparent or substantially transparent so as to allow light to pass through the label 18.

The wall 11 of the bottle 10 further defines a neck portion 25 defining a relatively narrow opening at the top of the bottle body and a slender shoulder section 26 smoothly conjoining the neck 25 bottle body 13. In the preferred embodiment, a label 28, having the same color as label 18 encircles the neck portion. A closure cap 30, having the same color as label 28 and 18, is engageable to the top of the neck portion 11 to seal the bottle 10 in a liquid-tight manner.

As will be appreciated from FIGS. 1 and 2, the height H, of the label 18 is chosen so as to extend over a substantial area of the rear portion 16 of the bottle 10. In the preferred embodiment the height H of the label 18 extends from close to the base 24 of the bottle 10 to close to the shoulder 26 of the bottle 10. Also, as can be seen in FIG. 5, the width W of the label 18 extends for no more than half the circumference of the bottle 10. It is preferable that label 18 assume the shape of the surface of the bottle onto which the label is to be attached.

In use, the bottle 10 is filled and sealed with the intended liquor. The solid colour provided or the surface 20 of the label is visible through the contents and provides a uniform black hue to the liquor and the wall. The neck label 28 also provides a uniform black appearance so that the net effect is a monolithic black container. At the same time however, the label 18 does not obscure the contents so that the clarity and implicit purity of the contents may be observed.

The limited extent of the label 18 about the wall also reduces the labelling cost and avoids unsightly seams in the label. As the contents of the bottle are consumed, the black inner surface maintains the coloration of the bottle and the overall pleasing appearance. By extending over the major extent of the rear surface 16, the monolithic appearance of the bottle is maintained.

1. A bottle with transparent walls having front and rear portions; a first label extending over a substantial extent of the surface of one of said portions; said label having an inwardly and outwardly directed surface; said inwardly directed surface engaging an opposed surface of said bottle; said inwardly directed surface having a uniform solid color to contrast with contents of said bottle.

2. The bottle of claim 1, wherein said inwardly directed surface of said label is devoid of indicia.

3. The bottle of claim 1, wherein said outwardly directed surface of said label carries indicia.

4. The bottle of claim 1, wherein said label is black in color.

5. The bottle of claim 1, further comprising a neck portion having a second label of the same color as said first label and encircling said neck portion.

6. The bottle of claim 1, wherein the width of the first label is not greater than half the circumference of the bottle.

7. A bottle with transparent walls having front and rear portions; a first label extending over a substantial extent of the surface of one of said portions; said label having an inwardly directed and outwardly directed surface; said inwardly directed surface engaging an opposed surface of said bottle, having a uniform solid black color to contrast with contents of said bottle, and devoid of indicia; said outwardly directed surface of said label having indicia; said portion of said bottle opposite the portion engaged with said label having indicia; and a neck portion having a second label of the same color as said first label and encircling said neck portion.
